(19) United States
(12) Patent Application Publication
(10) Pub. No.: US 2018/0141794 A1
(43) Pub. Date: May 24, 2018

(54) SLAT BUGGY

(71) Applicant: Andrew T. Altenburg, Truman, MN (US)

(72) Inventor: Andrew T. Altenburg, Truman, MN (US)

(21) Appl. No.: 15/358,910

(22) Filed: Nov. 22, 2016

(51) Int. Cl. B66F 9/065; A01K 1/015

(52) U.S. Cl. CPC B66F 9/065; B66F 2700/09; A01K 1/0151

(57) ABSTRACT

Apparatus for use in repairing and replacing flooring consisting of slotted concrete slats over a gathering pit in an animal barn, comprising a manually operable engine driven wheeled vehicle characterized by being supportable on a slotted concrete slat flooring and on the area proximate thereto, a pair of spaced apart parallel rigid forward extending arms pivotally mounted to the vehicle at their proximal ends, slat engaging tools extending from the distal ends of the arms for releasably engaging a flooring concrete slat, and a manually operated hydraulic actuated member coupled between the arms and the vehicle for selectively pivotally raising and lowering the arms to lift and deposit an engaged slat.

### FIELD OF THE INVENTION

This invention relates generally to animal pens and, more specifically to an apparatus for use in repairing and replacing the slat flooring of an animal pen.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Animal pens, such as hog pens, are commonly used in the industry for raising, nurturing and marketing domesticated animals. Referring to FIG. 1 many pens 10 are in an enclosed barn, which has a slatted flooring of slotted slabs of concrete, usually referred to as slats 11, for holding the animals over a pit, which accumulates the animals' droppings.

Referring to FIGS. 2 and 3 of the drawings, FIG. 2 is a partial cross-sectional side view showing some of the components that make up the animal pen flooring and FIG. 3 shows a perspective view of an individual concrete slat 11.

The animal pen slatted flooring generally comprises a gathering pit 13 for the collection of animal wastes. Gathering pit 13 includes an encompassing sidewall 14 having a ledge 14a extending therefrom, a plurality of preferably cement posts 15 extending vertically upwards from a floor 13b of the gathering pit 13, and a plurality of cement beams 16 extending along the entire width or length of the gathering pit 13 with the plurality of cement beams 16 supported on a top end of the plurality of posts 15. The concrete slats 11 are then supported by the ledge 14a of the encompassing sidewall 14 and the plurality of cement beams 16 to enclose the entire gathering pit 13.

Each of the concrete slats 11 include a plurality of slots 12 that extends from a topside 11a to a bottom side 11b of the slat 11 with plurality of slots 12 functioning to provide an avenue for animal waste to escape from the animal supporting topside 11a to the bottom side 11b of the slat 11.

During use of the animal pen the concrete slats 11, and some of the supporting structure including cement posts 15 and cement beams 16, deteriorate over time and need to be replaced. Initial construction and installation does not present a serious problem since the enclosing barn is usually built after the pit and flooring have been completed. Since the slats and supports are heavy and somewhat cumbersome, industrial type equipment is needed in order to accomplish the process of replacing the slats within the confines of a roofed barn with some degree of efficiency and at a reasonable cost.

One system for slat replacement uses a stationary large base with an attached frame having an extended arm which is carried by the frame to reach the flooring slats which need replacement Another device utilizes a large non-movable structure with outriggers for providing stability and an upwardly extended rotatable pedestal with a pivotally mounted boom. Apparently the latter is also intended to be adaptable for remote control in lieu of manual control by an experienced operator.

### BRIEF SUMMARY OF THE INVENTION

While the prior art describes the nature of the subject matter which the invention must deal with, i.e. the structure of the animal pen, the cumbersome weight and bulk of the cement slats, the need for and difficulty of removal of deteriorated slats, etc., it does not deal with the nature of all of the somewhat complex functions necessary to complete the process of removing and replacing the bulky damaged slats.

Rather than designing and building somewhat complex large and immobile structures as in the prior art, the instant invention utilizes commercially available vehicles modified by the inventor(s) as needed to provide less costly, maneuverable, manually operable apparatus with greater flexibility undertake and complete the task of repairing the slatted animal pen flooring.

The instant invention utilizes a stripped down, at least in part, commercially available engine-driven manually operated wheeled vehicle outfitted as necessary with manually controlled hydraulically powered devices all being manually operated by a skilled experienced operator. A pair of spaced-apart forward extending rigid parallel arms with attached tools at their distal ends for securing or firmly holding a slat, are pivotally mounted on the vehicle at their proximate ends and are hydraulically raised and lowered by the operator. The operator maneuvers the vehicle to place the tools at the damaged slat and operates the hydraulic device(s) as necessary to engage, lift and remove each damaged cement slat from its supporting structure, usually a beam and/or a post, and transport the damaged slat to a disposal site where it is deposited. The vehicle is also used to either pick up and return with a replacement slat or repeat the same steps on the next deteriorated slat. Since the vehicle is maneuvered and moved back and forth over at least part of the slat flooring, weight reduction of the vehicle is significant. The forces on the vehicle attributable to lifting and transporting the slat are balanced by rearward-attached weights. The tools for carrying the slat are releasably coupled to each slat that is removed and its replacement and are released from the slat when the slat is disposed.

A feature of the instant invention is its mobility and flexibility. The experienced operator of the vehicle, who also operates the various equipment controls, is able to adjust quite quickly as circumstances dictate. Also the vehicle with the attached, or attachable, equipment can be readily transported as needed from one barn location to another.

### BRIEF DESCRIPTION OF THE DRAWINGS

FIG. 1 is a partial cross-sectional view of an animal pen;

FIG. 2 is a partial cross-sectional side view showing some of the components that make up an animal pen flooring;

FIG. 3 shows a perspective view of an individual concrete slat for the animal pen flooring of FIG. 2;

FIG. 4 is a perspective view showing a slat buggy for use in repairing and replacing flooring comprising of slotted concrete slats over a gathering pit in an animal barn;

FIG. 5 is a perspective view showing a 3-point lift bracket cage assembly that is pivotably mounted to the vehicle of FIG. 4;

FIG. 6 is a close-up perspective view showing the T-bolt slat-grasping tool of FIG. 4;

FIG. 7 is a partial cross-sectional view showing the process of using the T-bolt slat-grasping tool of FIG. 6;

FIG. 8 is a close-up partial cross-sectional view showing the process of using the T-bolt slat-grasping tool; and

FIG. 9. is a close-up perspective view a pallet fork tool for use with the slat buggy of FIG. 4

### DESCRIPTION OF THE PREFERRED EMBODIMENT

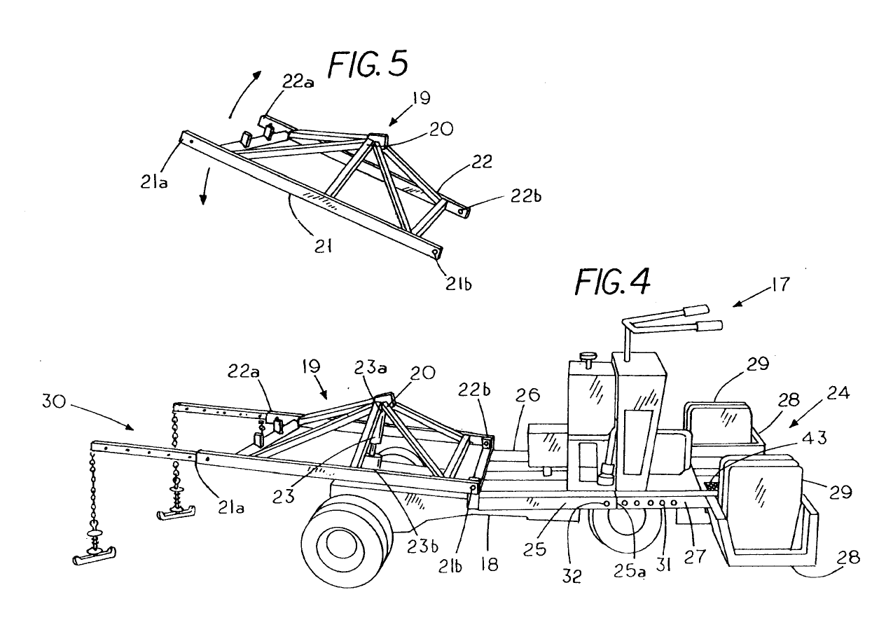

FIG. 4 is a perspective view showing an embodiment of an apparatus for use in repairing and replacing flooring comprising of slotted concrete slats over a gathering pit in an animal barn comprising a slat buggy 17. A feature of slat buggy 17 is that slat buggy 17 is manually operable to remove a slat 11 from the flooring, and raise it to a transporting position, transport slat 11 to a remote site and lower and release slat 11 at the remote site, raised a new/replacement slat from the remote site to a transporting position, transport new/replacement slat to the flooring and lower and release new/replacement slat 11 at the flooring.

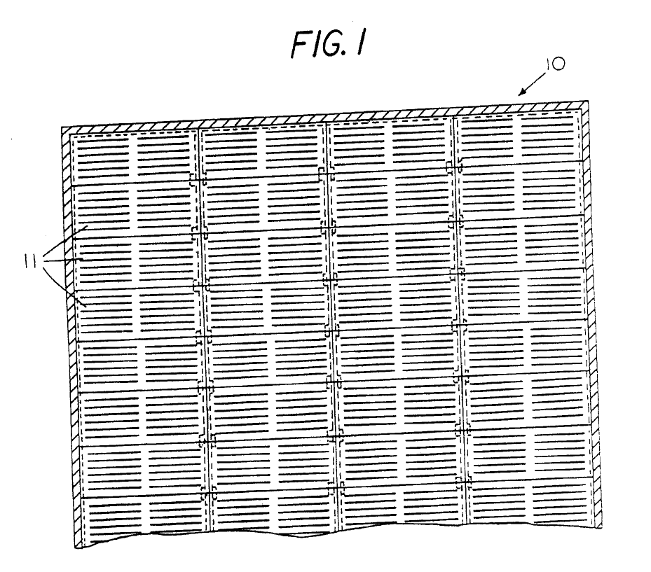

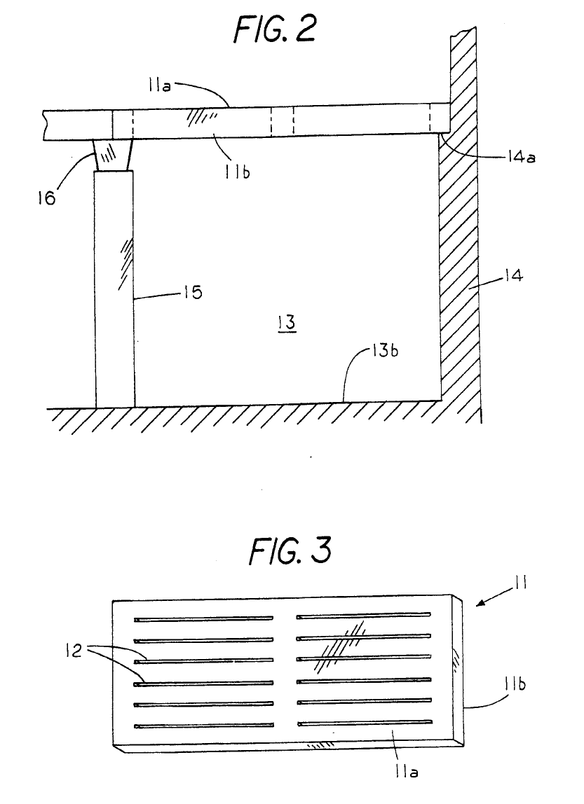

Slat buggy 17 generally comprises a manually operable engine driven wheeled vehicle 18 characterized by being supportable on a slotted concrete slat flooring and on the area proximate thereto similar to the slotted concrete slat flooring of the animal pen 10 of FIG. 1.

Slat buggy 17 includes a pair of spaced apart parallel rigid forward extending arms pivotally mounted to the engine driven wheeled vehicle 18 at their proximal ends and slat engaging tools extending from the distal ends of the arms for releasably engaging flooring concrete slat 11 and a manually operated hydraulic actuated member coupled between the arms and the engine driven wheeled vehicle 18 for selectively pivotally raising and lowering the arms to lift and deposit an engaged concrete slat 11.

In the embodiment of FIGS. 4 and 5 the pair of spaced apart parallel rigid forward extending arms are shown as comprising a 3-point lift bracket cage assembly 19 that includes a centrally located hydraulic cylinder mounting point 20 and a pair of spaced apart parallel rigid side members 21, 22 with the side members 21, 22 each having a slat tool receiving end 21a, 22a and an orifice 21b, 22b located distal the slat tool receiving end 21a, 22a for pivotally mounting the side members 21, 22 to the engine driven wheeled vehicle 18. A slat engaging tool comprising a t-bolt slat grasping tool 30 is shown extending from the slat tool receiving end 21a, 22a of each of the side members 21, 22 of bracket cage assembly 19 for releasably engaging flooring concrete slat 11.

In FIG. 4 the manually operated hydraulic actuated member is shown as comprising a hydraulic cylinder having a first end 23a connected to the hydraulic cylinder mounting point 20 of bracket cage assembly 19 and a second end 23b connected to the engine driven wheeled vehicle 18 with hydraulic cylinder 23 manually operated to selectively pivotally raise and lower bracket cage assembly 19 to lift and deposit the engaged concrete slat 11.

In the embodiment of FIG. 4, the slat buggy 17 is also shown including a weight-adjustable bracket assembly 24 mounted to engine driven wheeled vehicle 18 with weight-adjustable bracket assembly 24 operating to counter balance a weight of the engaged slat 11 supported by engine driven wheeled vehicle 18. Weight-adjustable bracket assembly 24 generally comprises a pair of spaced apart receiving tubes 25, 26 attached to opposing sides of engine driven wheeled vehicle 18 with the spaced apart receiving tubes 25, 26 each having an open end 25a for receiving an end of an extendable arm 27 therein with each extendable arm 27 including a weight supporting bucket 28 attached to or proximal to the opposing ends of the extendable arms 27. Although weight supporting buckets 28 may support a variety of different weights therein, the embodiment of FIG. 4 show weight supporting buckets 28 each support a plurality of tractor plate weights 29 therein.

In order to provide weight counter balance adjustability to weight-adjustable bracket assembly 24, the extendable arms 27 of weight-adjustable bracket assembly 24 each includes a plurality of spaced apart length adjusting orifice 31 extending therethrough along the length of the extendable arms 27 to allow the user to manually adjust the lengths of the extendable arms 27 to correspond to the weight to the engaged concrete slat 11. For example if slat buggy 17 is to engage a concrete slat 11 of a heavier weight the user would manually extend the length of extendable arms 27 to a desired corresponding length after which the user would then align the closes length adjusting orifice 31 to a locking slot 32 located on receiving tubes 25, 26 and then lock the extendable arms 27 in place by extending a locking device such as but not limited to a locking pin or locking bolt through locking slot 32 and the corresponding length adjusting orifice 31.

More specifically, weight-adjustable bracket assembly 22 operates to counter balance a weight of the engaged slat 11 by two different method, namely by supporting buckets 28 supporting of different amounts of weights therein and by adjustment of the length of the extendable arms 27 of weight-adjustable bracket assembly 24.

FIG. 4 also show slat buggy 17 including a user supported weight-balancing platform 43 attached to or proximal to an end of engine driven wheeled vehicle 18 distal the slat tool receiving end 21a, 22a of rigid side members 21, 22. User supported weight-balancing platform 43 provides an addition and/or supplemental option to counter balance a weight of the engaged slat 11.

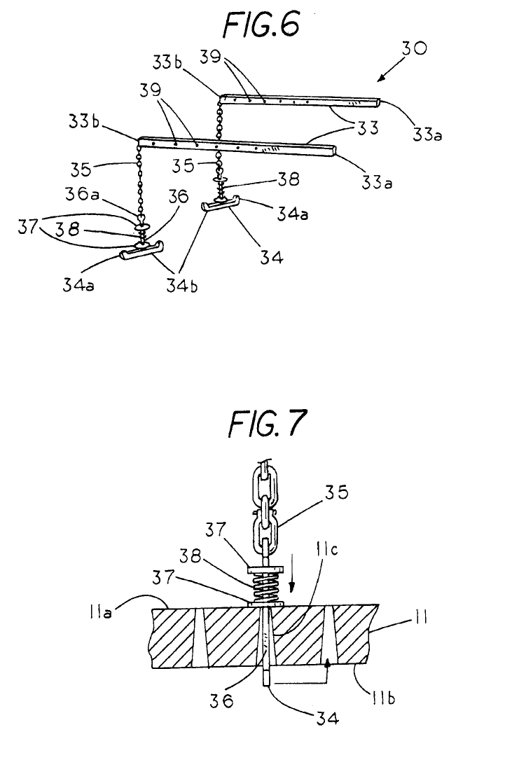

FIG. 6 is a close-up perspective view showing the T-bolt slat-grasping tool 30 of FIG. 4. T-bolt slat-grasping tool 30 generally comprises a pair of arms 33 each having a first end 33a for connection to one of the slat tool receiving ends 21a, 22a of lift bracket cage assembly 19 and a second end 33b. Arms 33 each also is shown including a plurality of orifices 33b extending therethrough along a length of each of the arms 33 for manual adjustment the length of each of the arms 33 with respect to the slat tool receiving ends 21a, 22a of lift bracket cage assembly 19.

T-bolt slat-grasping tool 30 also includes a slat engaging base member 34 having a riser 34a located at each of the ends of the slat engaging base member 34 and a slat engaging surface 34b. Extending from slat engaging surface 34b midway between the riser 34a is shaft 36 supporting a pair of washers 37 and a compression spring 38 thereon with the compression spring 38 positioned on shaft 36 between the washers 37. In the embodiment of FIG. 6 the shaft 36 includes an enlarged end 36a to maintain washers 37 and compression spring 38 on shaft 36. The slat engaging base member 34 is shown connected to arm 33 through the use of a chain 35 which is connected to the enlarged end 36a of shaft 36 at one end and connected to the second end 33b of arm 33 at the opposing end of chain 35.

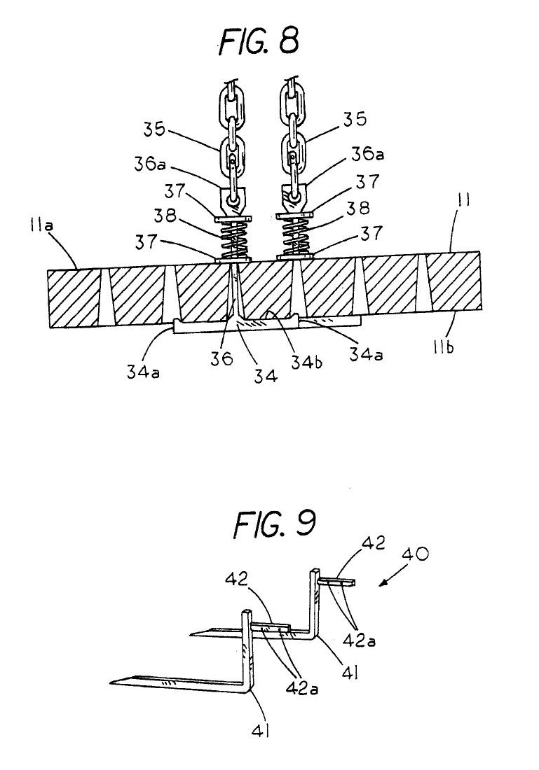

FIGS. 7 and 8 are partial cross-sectional views showing the process of using the T-bolt slat-grasping tool 30 to engage and grasp a slat 11. As shown in FIG. 7 the process starts with the alignment of the base member 34 of each of the T-bolt slat-grasping tool 30 to the centrally located slots 11c located on slat 11, which likely is also identified as the slots that are located proximal the midpoint between the ends of slat 11. Once aligned T-bolt slat-grasping tool 30 is then pushed downwards until the base member 34 is extended completely through the centrally located slots 11c of slat 11 after which, as shown in FIG. 8, the base member 34 is then rotated such that the base member 34 runs at an angle to the direction of the centrally located slots 11c of slat 11. For example, in FIG. 8 the base member 34 is rotated to a direction running perpendicular to the direction of the centrally located slots 11c.

As T-bolt slat-grasping tool 30 is pushed downwards, compression spring 38 increases a counter force against the enlarged end 36a of shaft 36 such that once the user's downward pressure on T-bolt slat-grasping tool 30 is released, compression spring 38 will pull base member 34 towards the underside 11b of slat 11 until the slat engaging surface 34b of slat 34 is against the underside 11b of slat 11. In the embodiment of FIG. 8, the risers 34a are shown each engaging the slots on slat 11 located adjacent or proximal centrally located slots 11c to assist in preventing the rotation of base member 34 after the slat engaging surface 34b of slat 34 engages the underside 11b of slat 11.

In order to disengage T-bolt slat-grasping tool 30 from slat 11, the user pushes T-bolt slat-grasping tool 30 downwards until the base member 34 disengages the underside 11b of slat 11 after which the base member 34 is then rotated to a direction running parallel to the direction of the centrally located slots 11c. T-bolt slat-grasping tool 30 may then be removed from slat 11

FIG. 9. is a close-up perspective view of a pallet fork tool 40 for use with the slat buggy 17 of FIG. 4. Pallet fork tool 40 is shown generally comprising a pair of L-shaped slat supporting base member 41 each having an arm 42 extending therefrom for connection to one of the slat tool receiving ends 21a, 22a of lift bracket cage assembly 19. The arms 42 each is also shown including a plurality of orifices 42a extending therethrough along a length of each of the arms 42 for manual adjustment the length of each of the arms 42 with respect to the slat tool receiving ends 21a, 22a of lift bracket cage assembly 19.

The present invention also includes a method for repairing and replacing the flooring comprising of slotted concrete slats 11 over a gathering pit 13 in an animal barn, that includes the steps of (1) providing a manually operated wheeled vehicle 17 suitable for being supported on a flooring comprising of slotted concrete slats 11 and on the area adjacent the flooring, the vehicle 17 having a pair of spaced-apart forward extendable rigid parallel arms 21, 22 with slat-engaging tools 30, 40 at their distal ends, the arms 21, 22 pivotally mounted at their proximal ends to the vehicle 17 and a hydraulically operated member 23 coupled between the arms 21, 22 and the vehicle 17 for pivotally raising and lowering the arms 21, 22; (2) operating the vehicle 17 to maneuver the vehicle 17 to position the slat engaging tools 30, 40 proximate a used slat 11 in the slatted flooring; then, (3) placing the slat engaging tools 30, 40 to engage the used slat 11; (4) manually controlling the hydraulically operated member 23 to pivotally raise the arms 21, 22 to lift the damaged slat 11 from its supporting structure; (5) maneuvering the vehicle 17 to carry the damaged slat 11 to a disposal site; then, (6) removing the slat engaging tools 30, 40 from the used slat 11 to release the used slat 11 at the disposal site.

The aforementioned may also include the steps of (7) operating the vehicle 17 to maneuver it to a site having replacement slats; (8) placing the slat engaging tools 30, 40 to engage a replacement slat; (9) manually controlling the hydraulically operated member 23 to lift the replacement slat; and then, operating the vehicle 17 to deposit the replacement slat in the flooring.

I claim:

1. Apparatus for use in repairing and replacing flooring consisting of slotted concrete slats over a gathering pit in an animal barn, comprising:
a manually operable engine driven wheeled vehicle characterized by being supportable on a slotted concrete slat flooring and on the area proximate thereto;
a pair of spaced apart parallel rigid forward extending arms pivotally mounted to said vehicle at their proximal ends;
slat engaging tools extending from the distal ends of said arms for releasably engaging a flooring concrete slat; and
a manually operated hydraulic actuated member coupled between said arms and said vehicle for selectively pivotally raising and lowering said arms to lift and deposit an engaged slat.

2. Apparatus for use in repairing and replacing flooring as described in claim 1 wherein said vehicle is manually operable to transport a slat raised from the flooring and lower it at a remote site.

3. Apparatus for use in repairing and replacing flooring as described in claim 2 wherein said tools are operable to engage a slat to remove said slat from the flooring and release said slat at a remote site.

4. Apparatus for use in repairing and replacing flooring as described in claim 3 wherein said vehicle is manually operable to transport a raised slat from a remote site and lower it at the flooring.

5. Apparatus for use in repairing and replacing flooring as described in claim 4 wherein said tools are removable from the slat at the flooring.

6. Apparatus for use in repairing and replacing flooring as described in claim 5 wherein said pair of spaced apart parallel rigid forward extending arms pivotally mounted to said vehicle at their proximal ends comprises a 3-point lift bracket cage assembly that includes a centrally located hydraulic cylinder mounting point and a pair of spaced apart parallel rigid side members with said side members each having a slat tool receiving end and an orifice located distal said slat tool receiving end for pivotally mounting said side members to said vehicle; and
wherein said manually operated hydraulic actuated member comprises a hydraulic cylinder having a first end connected to said hydraulic cylinder mounting point of said bracket cage assembly and a second end connected to said vehicle, said hydraulic cylinder manually operated to selectively pivotally raise and lower said bracket cage assembly to lift and deposit an engaged slat.

7. Apparatus for use in repairing and replacing flooring as described in claim 6 including a weight-adjustable bracket assembly mounted to said vehicle with said weight-adjustable bracket assembly operating to counter balance a weight of said engaged slat supported by said vehicle, said weight-adjustable bracket assembly comprises a pair of spaced apart tubes attached to opposing sides of said vehicle, said spaced apart tubes each having an open end for receiving a first end of an extendable arm therein with each arm including a weight supporting bucket attached to a second end of said extendable arm.

8. Apparatus for use in repairing and replacing flooring as described in claim 7 including a user supported weight-balancing platform attached to an end of said vehicle distal said slat engaging tools.

9. Apparatus for use in repairing and replacing flooring as described in claim 7 wherein said slat engaging tools comprises a T-bolt slat-grasping tool.

10. Apparatus for use in repairing and replacing flooring as described in claim 7 wherein said slat engaging tools comprises a pallet fork tool.

11. Apparatus for use in repairing and replacing flooring comprising of slotted concrete slats over a gathering pit in an animal barn, comprising:
a manually operable engine driven wheeled vehicle characterized by being supportable on a slotted concrete slat flooring and on the area proximate thereto;
a 3-point lift bracket cage assembly that includes a centrally located hydraulic cylinder mounting point and a pair of spaced apart parallel rigid side members with said side members each having a slat tool receiving end and an orifice located distal said slat tool receiving end for pivotally mounting said side members to said vehicle;
a slat engaging tools extending from the slat tool receiving end of each of the side members of said bracket cage assembly for releasably engaging a flooring concrete slat;
a hydraulic cylinder having a first end connected to said hydraulic cylinder mounting point of said bracket cage assembly and a second end connected to said vehicle, said hydraulic cylinder manually operated to selectively pivotally raise and lower said bracket cage assembly to lift and deposit an engaged slat; and
a weight-adjustable bracket assembly mounted to said vehicle with said weight-adjustable bracket assembly operating to counter balance a weight of said engaged slat supported by said vehicle.

12. The apparatus for use in repairing flooring as described in claim 11 wherein said weight-adjustable bracket assembly comprises a pair of spaced apart tubes attached to opposing sides of said vehicle, said spaced apart tubes each having an open end for receiving a first end of an extendable arm therein with each arm including a weight supporting bucket attached to a second end of said extendable arm.

13. The apparatus for use in repairing flooring as described in claim 12 wherein said extendable arms of said weight-adjustable bracket assembly each includes a plurality of orifices extending therethrough along a length of each of said arms for manual adjustment of a length of said arm to further counter balance a weight of said engaged slat.

14. The apparatus for use in repairing flooring as described in claim 13 wherein said weight supporting buckets of said weight-adjustable bracket assembly each support a plurality of tractor plate weights therein.

15. The apparatus for use in repairing flooring as described in claim 14 wherein said spaced apart tubes of said weight-adjustable bracket assembly are spaced apart parallel from each other.

16. Apparatus for use in repairing flooring as described in claim 14 wherein said slat engaging tools comprises a T-bolt slat-grasping tool.

17. Apparatus for use in repairing flooring as described in claim 14 wherein said slat engaging tools comprises a pallet fork tool.

18. Apparatus for use in repairing and replacing flooring as described in claim 14 including a user supported weight-balancing platform attached to an end of said vehicle distal said slat engaging tools.

19. A method for repairing and replacing the flooring consisting of slotted concrete slats over a gathering pit in an animal barn, comprising the steps of:
providing a manually operated wheeled vehicle suitable for being supported on a flooring consisting of slotted concrete slats and on the area adjacent said flooring, said vehicle having a pair of spaced-apart forward extendable rigid parallel arms with slat-engaging tools at their distal ends, said arms pivotally mounted at their proximal ends to said vehicle and a hydraulically operated member coupled between said arms and said vehicle for pivotally raising and lowering said arms;
operating the vehicle to maneuver said vehicle to position said slat engaging tools proximate a used slat in the slatted flooring; then,
placing said slat engaging tools to engage said used slat;
manually controlling said hydraulically operated member to pivotally raise said arms to lift the damaged slat from its supporting structure;
maneuvering the vehicle to carry the damaged slat to a disposal site; then,
removing the slat engaging tools from the used slat to release the used slat at the disposal site.

20. The method for repairing the flooring consisting of slotted concrete slats as described in claim 19, including the steps:
operating the vehicle to maneuver it to a site having replacement slats;
placing said slat engaging tools to engage a replacement slat;
manually controlling said hydraulically operated member to lift said replacement slat; then,
operating the vehicle to deposit the replacement slat in the flooring.
